(19) United States
(12) Patent Application Publication
(10) Pub. No.: US 2004/0135516 A1
(43) Pub. Date: Jul. 15, 2004

(54) Velocity modulation device and projection type display unit

(76) Inventor: Toshiya Takagishi, Kanagawa (JP)

Correspondence Address: Ronald P Kananen, Rader Fishman & Grauer, Suite 501, 1233 20th Street NW, Washington, DC, 20036, US

(21) Appl. No.: 10/476,763

(22) PCT Filed: Aug. 29, 2002
(86) PCT No.: PCT/JP02/08746

(30) Foreign Application Priority Data
Aug. 29, 2001 (JP) 2001-260333

(51) Int. Cl. H01J 29/52

(52) U.S. Cl. 315/30; 315/407

(57) ABSTRACT

It is capable of independently modulating the scanning velocities of multiple electron beams having a beam interval. Allowing a current to pass through the velocity modulation coils results in modulation of the scanning velocities of the multiple electron beams (19A, 19B) emitted from electron guns contained in a neck portion of a cathode ray tube to sharpen the outline of picture. The velocity modulation coils have a coil configuration including three upper coils (27A, 27B, and 27C) and lower three coils (28A, 28B, and 28C) for respectively generating asymmetrical quadri-pole magnetic fields. The magnetic fields independently generated by these two types of the velocity modulation coils allows the scanning velocities of the multiple electron beams (19A, 19B) to be almost independently modulated.

### TECHNICAL FIELD

This invention relates to a velocity modulation apparatus for modulating the scanning velocities of multiple electron beams and a projection-type display using the same. More particularly, the invention relates to a velocity modulation apparatus including velocity modulation coils having a coil configuration such that three upper coils and three lower coils are provided for generating asymmetrical quadri-pole magnetic fields, thereby permitting the scanning velocities of multiple electron beams to be independently modulated and a projection-type display equipped with the same.

### BACKGROUND ART

A projection-type display utilizing a projection-type cathode ray tube generally includes three projection-type cathode ray tubes consisting of green, blue, and red cathode ray tubes that is positioned at a predetermined distance away from a projection screen whereby enlarged pictures may be displayed as compared with each of the reproduced pictures represented on the respective faceplates of the three projection-type cathode ray tubes by projecting and displaying the reproduced pictures represented on the respective face plates to the projection screen with them being superposed.

FIG. 1 is an illustration showing a schematic configuration of important portions of the projection-type display. Projection-type cathode ray tubes 41G, 41B, and 41R for projecting the green, the blue, and the red pictures, respectively are provided with the faceplates 42G, 42B, and 42R on their panel sides, respectively.

A projection lens 43G for projecting a green picture is positioned away from, and facing to, the faceplate 42G of the panel portion of the projection-type cathode ray tubes 41G for projecting the green picture with their central axes being aligned with each other. Similarly, a projection lens 43B for projecting a blue picture is positioned away from, and facing to, the faceplate 42B of the panel portion of the projection-type cathode ray tube 41B for projecting the blue picture with their central axes being aligned with each other, and a projection lens 43R for projecting a red picture is positioned away from, and facing to, the faceplate 42R of the panel portion of the projection-type cathode ray tube 41R for projecting the red picture with their central axes being aligned with each other.

A projection screen 45 is positioned away from, and facing to, the projection lens 43G for projecting the green picture and the projection-type cathode ray tubes 41G for projecting the green picture at a predetermined distance with their central axes being aligned with one another.

FIG. 2 is a sectional diagram showing an exemplary configuration of a projection-type cathode ray tube 48 for use with a projection-type display. A glass valve constituting the projection-type cathode ray tube 48 has a panel portion 49a and a funnel portion 49b jointed to the panel portion 49a. An electron gun 51 is built in a neck part of the funnel 49b. The panel portion 49a is provided in the front end thereof with a faceplate 49a-1. Formed on the inside of the faceplate 49a-1 are a monochromatic fluorescence screen 49a-2 and an aluminum vapor-deposition film 50.

A main deflection yoke 53 is mounted around the funnel portion 49b, and a sub-deflection yoke 54 and a velocity modulation coil 55 are mounted on a side closer to the neck portion than the main deflection yoke 53. The sub-deflection yoke 54 adjusts optical distortion of the respective three-colored pictures projected on the screen 45 as shown in FIG. 1 to match the distortions of the three-color pictures. The velocity modulation coils 55 modulate the scanning velocity of an electron beam to emphasize the outline of an image and to improve sharpness of the displayed picture.

FIGS. 3A and 3B show the velocity modulation coil 55: FIG. 3A is a schematic side view thereof and FIG. 3B is a schematic front view thereof. In FIG. 3A, a first grid of the electron gun 51 is indicated as G1 and a fourth grid thereof is indicated as G4. The velocity modulation coils 55 are formed of saddle-shaped coils 57 and 58. A plane with which the coils 57 and 58 are arranged in an almost parallel contact is referred to as a horizontal plane (a horizontal direction) and a direction vertical to this plane is referred to as the vertical direction. By passing currents for allowing velocity modulation through the coils 57 and 58, a magnetic field is generated which is oriented in the vertical direction. This magnetic field interacts with an electron beam 59 moving along a tube axis thereof, applying the horizontal force to the beam to modulate the scanning velocity thereof.

One electron beam 59 emitted from the electron gun 51 is modulated in velocity thereof by the velocity modulation coil 55 and is further deflected by the sub-deflection yoke 54 and the main deflection yoke 53 in a predetermined direction, and then impinges on the monochromatic (either green, blue, or red) fluorescent screen 49a-2.

Although the projection-type cathode ray tube 48 described above has emitted a single electron beam, it is conceivable that, in order to increase the intensity of a picture, a cathode ray tube emitting multiple electron beams is utilized. In such multi-beam-emitting cathode ray tube, if two electron beams, for example, scan the same point on the fluorescent screen, the intensity may be saturated to fail to double the brightness of the picture. Thus, shifting their scanned points in time may permit the brightness thereof to be doubled. As a consequence, electron beams have their own beam spaces and pass through different orbits in such the cathode ray tube shifting the scanned points and emitting multiple electron beams.

Since the velocity modulation coils 55 mentioned above generate a substantially uniform double-pole magnetic fields between the upper and the lower coils 57 and 58, two electron beams, for example, having the beam space exhibit the similar movement. It is then necessary to synchronize the actions of the magnetic fields according to the velocity modulation coils with the respective image signals of the respective electron beams because the image signals are shifted by about two through ten H lines (H indicates horizontal scanning line). In other words, it is necessary to act the magnetic fields of the respective velocity modulation coils on only its corresponding one electron beam.

It is, therefore, an object of the invention to provide a velocity modulation apparatus capable of independently modulating the velocities of multiple electron beams and to provide a projection-type display having such the scanning velocity modulation apparatus.

### DISCLOSURE OF INVENTION

A velocity modulation apparatus according to the invention allows a current to pass through a velocity modulation coil of cathode ray tube to modulate scanning velocities of multiple electron beams emitted from electron guns built in a neck portion of the cathode ray tube, thereby sharpening an outline of a picture, wherein the velocity modulation coil has a coil configuration including three upper coils and three lower coils relative to an emitting direction of each of the electron beam, for respectively generating asymmetrical quadri-pole magnetic fields to independently modulate the scanning velocities of the multiple electron beams.

A projection-type display according to the invention is equipped with a velocity modulation apparatus allowing a current to pass through a velocity modulation coil of cathode ray tube to modulate scanning velocities of multiple electron beams emitted from electron guns built in a neck portion of the cathode ray tube, thereby sharpening an outline of a picture, wherein the velocity modulation coil has a coil configuration including three upper coils and three lower coils relative to an emitting direction of each of the electron beams, for respectively generating asymmetrical quadri-pole magnetic fields to independently modulate the scanning velocities of the multiple electron beams.

Since the velocity modulation coil constituting the velocity modulation apparatus has a coil configuration including three upper coils and three lower coils for respectively generating asymmetrical quadri-pole magnetic fields, the quadri-pole magnetic field by the three upper coils, for example, modulates the scanning velocity of only one electron beam (an electron beam that leads the other electron beam in scanning) while the quadri-pole magnetic field by the three lower coils modulates the scanning velocity of the other electron beam (the other electron beam following the leading electron beam in scanning), thereby allowing the scanning velocities of the multiple electron beams to be independently modulated.

### BRIEF DESCRIPTION OF DRAWINGS

FIG. 1 is an illustration showing a schematic configuration of important portions of the projection-type display;

FIG. 2 is a sectional side view of conventional projection-type cathode ray tube having an exemplary configuration thereof;

FIGS. 3A and 3B are schematic diagrams showing conventional velocity modulation coils;

FIGS. 4A and 4B are diagrams each showing a configuration of important portions of the projection-type display equipped with projection-type cathode ray tubes each having a velocity modulation apparatus of the invention;

FIG. 5 is a sectional side view of the projection-type display of the invention;

FIG. 6 is a side view of a magnetic flux generator;

FIG. 7 is an illustration for illustrating the loci of scanning lines by two scanning beams on a fluorescent screen;

FIG. 8 is a front view of a sub-deflection yoke;

FIGS. 9A and 9B are schematic diagrams showing velocity modulation coils for generating double-pole magnetic fields; and

FIGS. 10A-10C are schematic diagrams showing velocity modulation coils using quadri-pole magnetic fields.

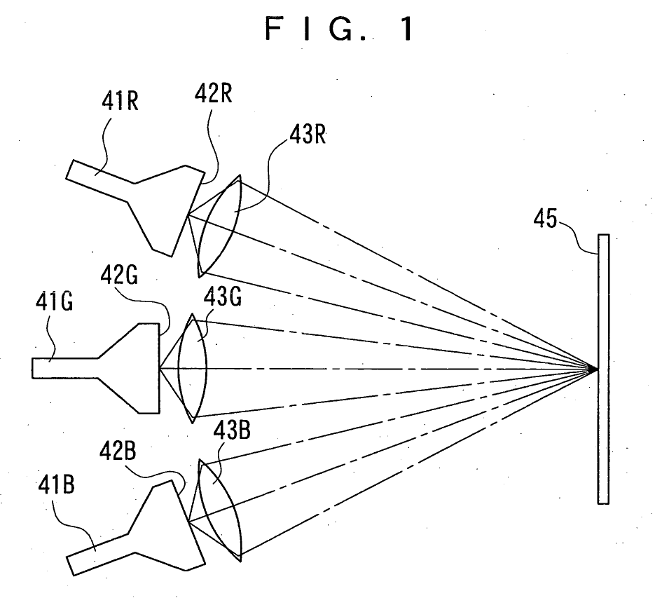

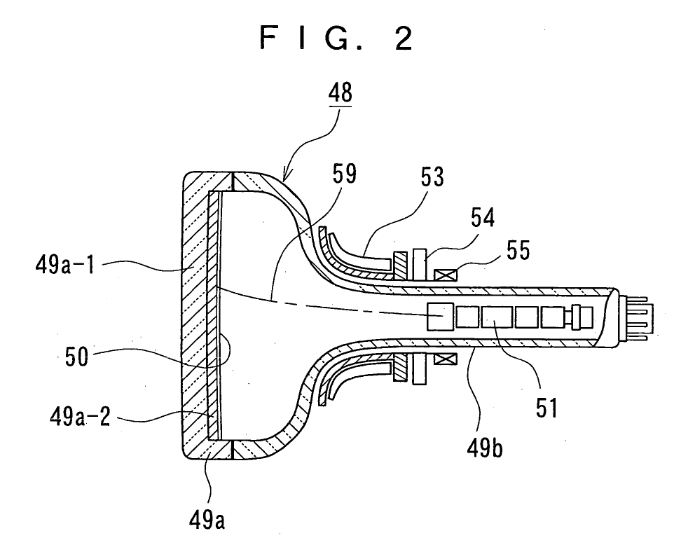

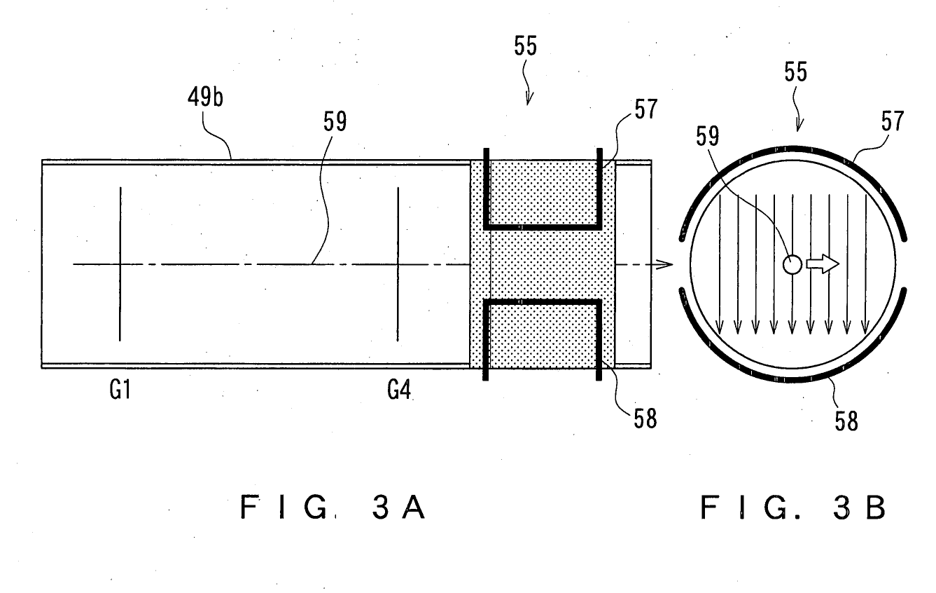

### BEST MODE FOR CARRYING OUT THE INVENTION

Referring to accompanying drawings, the invention will now be described with particular reference to a velocity modulation apparatus and a projection-type display in accordance with an embodiment of the invention.

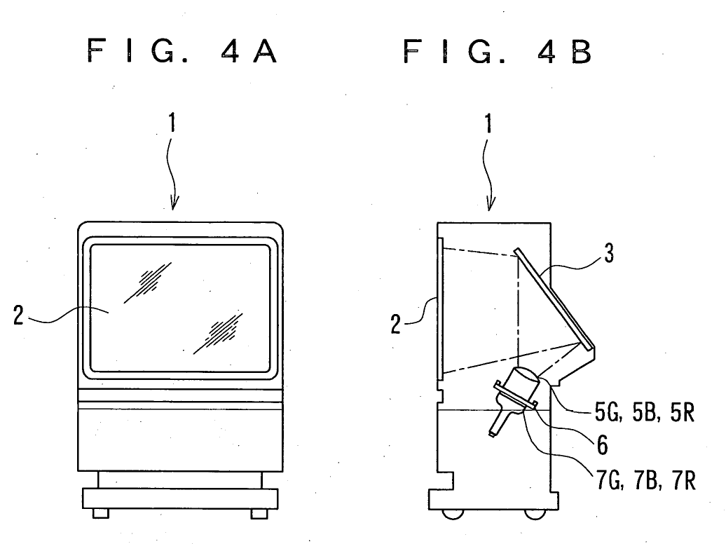

FIGS. 4A and 4B are diagrams each showing a configuration of important portions of the projection-type display equipped with projection-type cathode ray tubes each having a velocity modulation apparatus of the invention; FIG. 4A is a front view thereof and FIG. 4B is a sectional side constructional view thereof.

The projection-type display 1 is provided on the front end thereof with a projection screen 2 and on the rear end with a reflective mirror 3 facing the projection screen 2. The reflective mirror 3 is arranged between the projection screen 2 and a lens 5G for projecting a green picture with their central axes being aligned with one another. A lens coupler 6 is provided to physically couple and hold the lens 5G for projecting a green picture, a projection lens 5B for projecting a blue picture, and a projection lens 5R for projecting a red picture.

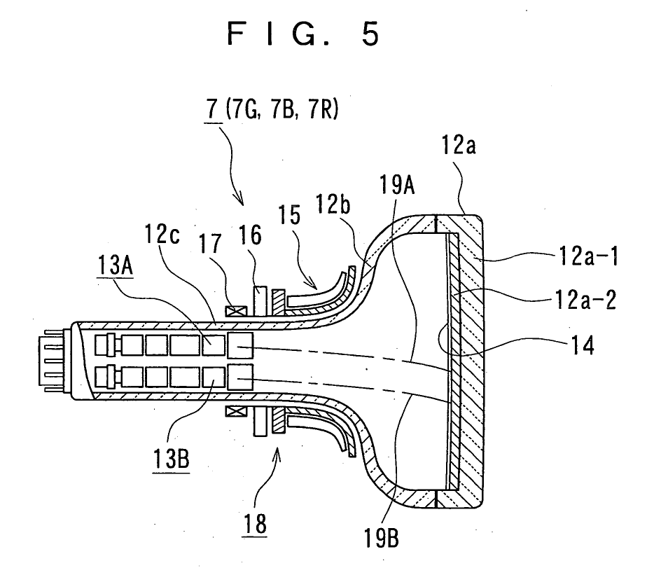

The projection lens 5G for projecting the green picture is disposed to oppose, and spaced apart from, a faceplate 12a-1 (see FIG. 5) of a panel portion of a projection-type cathode ray tube 7G for projecting a green picture, which will be described, with their central axes being aligned with each other. Similarly, the projection lens 5B for projecting a blue picture is disposed to oppose, and spaced apart from, a faceplate 12a-1 of a panel portion of a projection-type cathode ray tube 7B for projecting a blue picture with their central axes being aligned with each other, and the projection lens 5R for projecting a red picture is disposed to oppose, and spaced apart from, a faceplate 12a-1 of a panel portion of a projection-type cathode ray tube 7R for projecting a red picture with their central axes being aligned with each other.

In the projection-type display 1, the green picture is displayed (reflected) on the faceplate 12a-1 of the panel portion of the projection-type cathode ray tube 7G for projecting the green picture. Similarly, the blue picture is displayed on the faceplate 12a-1 of the panel portion of the projection-type cathode ray tube 7B for projecting the blue picture, and the red picture is displayed on the faceplate 12a-1 of the panel portion of the projection-type cathode ray tube 7R for projecting the red picture. These green, blue, and red pictures are projected on the projection screen 2 via the reflective mirror 3 after they are collimated and enlarged by the respective corresponding projection lenses 5G, 5B, and 5R held together by the lens coupler 6. Thus, a color picture is formed as a result of superposition of the green, blue, and red pictures.

FIG. 5 is a sectional side view of each of the projection-type cathode ray tubes 7G, 7B and 7R wherein multiple electron beams are emitted. A glass bulb constituting one projection-type cathode ray tube 7 comprises panel portion 12a, a funnel portion 12b jointed to the panel portion 12a, and a neck portion 12c contiguous to the funnel 12b. The neck portion 12c has a pair of built-in upper and lower electron guns 13A and 13B, respectively. The panel portion 12a has on the front end thereof the faceplate 12a-1, and a monochromatic fluorescent screen 12a-2 and an aluminum vapor-deposition film 14 formed on the inner surface of the faceplate 12a-1. The aluminum vapor-deposition film 14 is not inevitable, and may be omitted.

A main deflection yoke 15 is mounted around the funnel portion 12b and a sub-deflection yoke 16 serving as a convergence yoke is also mounted on a side closer to the neck portion 17 than the main deflection yoke 15. The sub-deflection yoke adjusts the optical distortion of the respective three-color pictures appeared on the screen 2 as shown in FIG. 4A and 4B, so that the distortions of the three-color pictures are matched. Mounted a side closer to the electron guns 13A and 13B than the sub-deflection yoke 16 are velocity modulation coils as a velocity modulation apparatus.

The velocity modulation coils 17 modulates the scanning velocities of the respective electron beams as described above to emphasize an outline of an image, thereby improving the sharpness of the displayed picture. The main deflection yoke 15, the sub-deflection yoke 16, and the velocity modulation coils 17 are integrated to form a magnetic flux generator 18.

Electron beams 19A and 19B respectively emitted from the electron guns 13A and 13B are modulated in their scanning velocities by the velocity modulation coils 17, respectively deflected in a predetermined direction by the sub-deflection yoke 16 and the main deflection yoke 15, and then projected on the associated monochromatic fluorescent screen 12a-2 of either green, blue, or red. Further, details of the velocity modulation coils 17 will be described later.

In the invention, the velocity modulation coils 17 have a coil configuration such that three upper coils 27A, 27B, and 27C and three lower coils 28A, 28B, and 28C relative to an emitting direction of each of the electron beams, are provided for generating asymmetrical quadri-pole magnetic fields, which will be described in more detail later. The three upper coils 27A, 27B, and 27C and three lower coils 28A, 28B, and 28C independently modulate the scanning velocities of the multiple electron beams having a beam interval between them.

FIG. 6 is an enlarged side view of the magnetic flux generator 18 shown in FIG. 5. The magnetic flux generator 18 is formed with integrating the main deflection yoke 15, the sub-deflection yoke 16, and the velocity modulation coils 17. The main deflection yoke 15 comprises a horizontal deflecting coil 20, a vertical deflecting coil 21, and a deflection yoke core 22. A separator 23 holds the horizontal deflecting coil 20, the vertical deflecting coil 21, and the deflection yoke core 22, respectively. The separator 23 has a projection section projecting along a direction of the electron guns to hold the sub-deflection yoke 16 and the scanning velocity modulation coils 17 by the projection section thereof.

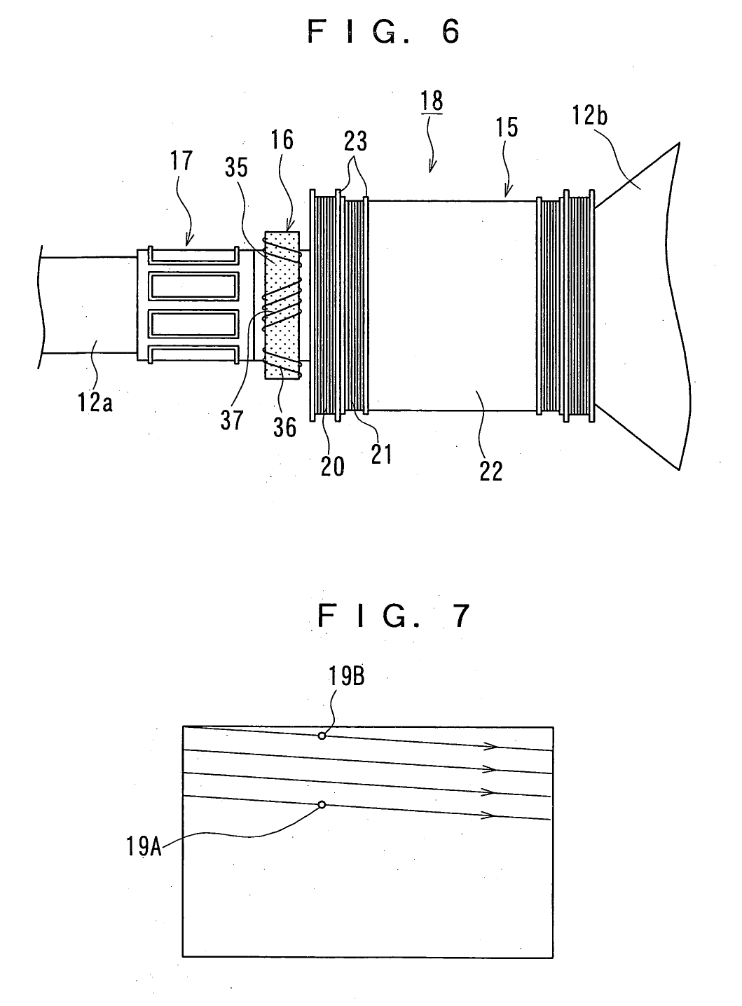

FIG. 7 is an illustration for illustrating the loci of scanning lines by the two electron beams 19A and 19B on the fluorescent screen. The upper electron gun 13A emits a first electron beam 19A while the lower electron gun 13B emits a second electron beam 19B. The first electron beam 19A is scanned on the fluorescent screen with leading the second electron beam 19B, and the second electron beam 19B is scanned with a little delay on the fluorescent screen with shifting the beams in the vertical direction thereof by an amount of about 2-10 H lines (H being a horizontal scanning line). Note, however, that no horizontal shift occurs.

In FIG. 7, the electron beams 19A and 19B are shifted from each other by 3 H lines in the vertical direction. This is because shifting their scanning positions in time results in approximately doubling the brightness to avoid the saturation of intensity and failing to double the brightness (luminescence intensity) when the electron beams 19A and 19B are simultaneously scanned on the same position on the fluorescent screen, as described above.

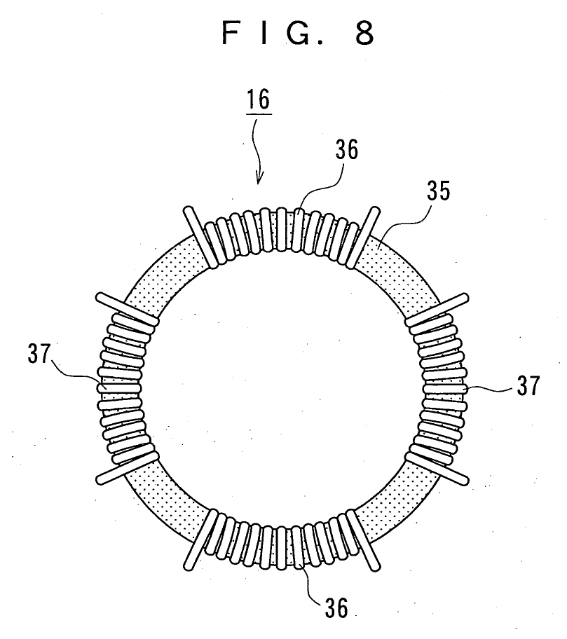

FIG. 8 is a front view of the sub-deflection yoke 16. The sub-deflection yoke 16 is formed so that vertical sub-deflecting coils 36 are wound by toroidal form on an annular magnetic core 35 at upper and lower portions, and horizontal sub-deflecting coils 37 are wound on it at right and left portions. As described above, the sub-deflection yoke 16 adjusts the optical distortion of each of the pictures associated with the respective three colors appeared on the screen 2 to match distortions of the three-color pictures.

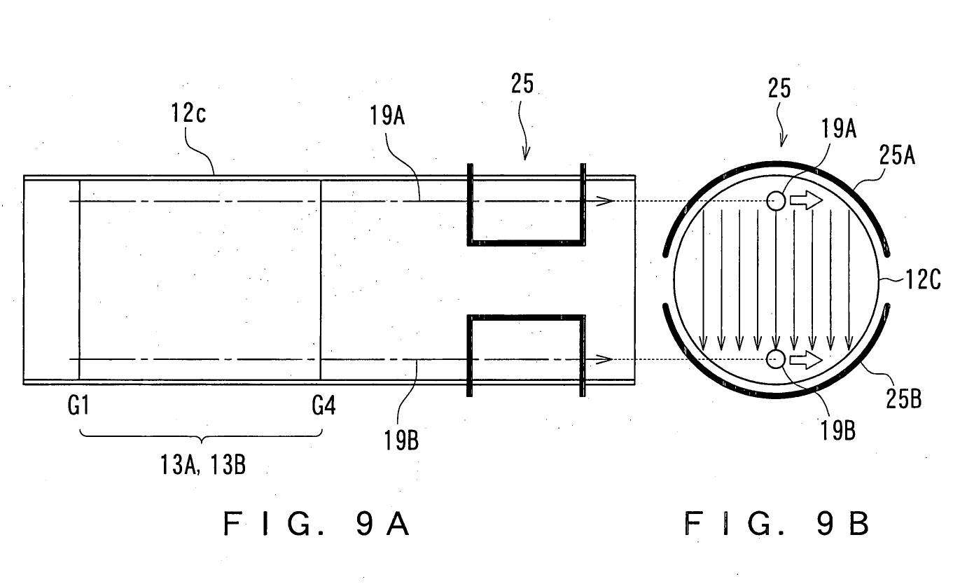

Next, The velocity modulation apparatus of the invention will now be described. For convenience in explanation, FIGS. 9A and 9B illustrate velocity modulation coils generating a double-pole magnetic field for a conventional use. FIG. 9A and FIG. 9B show a schematic side view thereof and a schematic front view thereof, respectively. The velocity modulation coils are located behind the deflection yoke 15 (at a side of the electron guns) to modulate scanning velocities of the electron beams at this location.

Elements G1 and G4 shown in FIG. 9A indicate a first grid and a fourth grid, respectively. As stated previously, the velocity modulation coils 25 generate substantially uniform double-pole magnetic field by the upper coils 25A and the lower coils 25B, thereby moving the two electron beams 19A and 19B similarly.

However, when the image signals relative to the respective electron beams are shifted by, for example, 10 H lines (10 scanning lines), actions of the magnetic fields by the velocity modulation coils also need to be synchronized accordingly with the corresponding image signals. That is, it is necessary for each of the magnetic fields by the velocity modulation coils to act on the only one of the two electron beams.

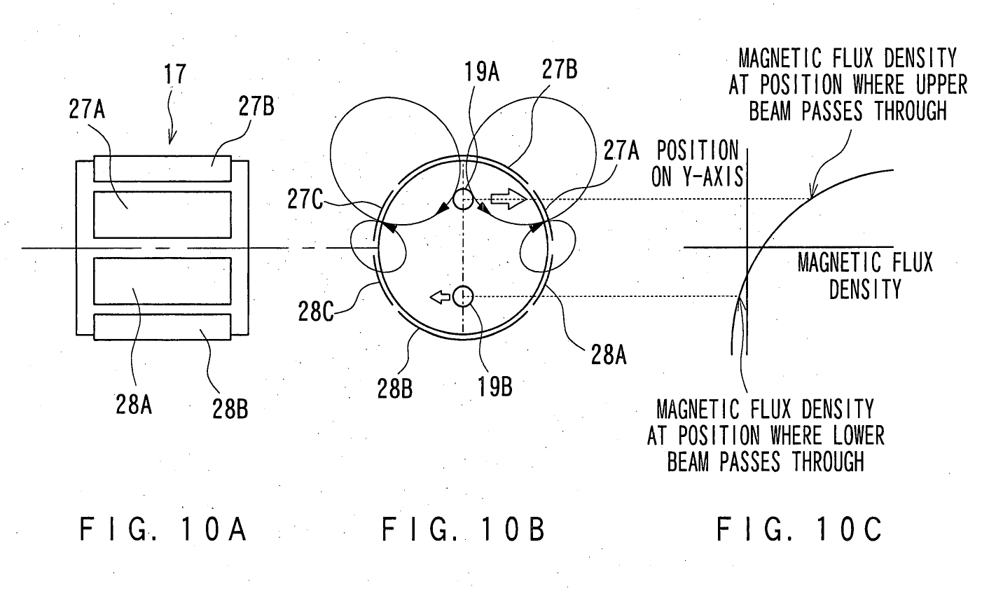

As one way to implement this, it is conceivable to use asymmetrical quadri-pole magnetic fields. FIGS. 10A-10C show velocity modulation coils 17 using the quadri-pole magnetic fields according to the invention: FIGS. 10A and 10B are a schematic side view thereof and a front view thereof, respectively; and FIG. 10C is an illustration showing relationship between magnetic flux density and the upper and lower electron beams.

As shown in FIGS. 10A and 10B, three upper coils 27A, 27B, and 27C and three lower coils 28A, 28B, and 28C relative to an emitting direction of each of the electron beams are wound to generate the respective asymmetrical quadri-pole magnetic fields.

As shown in FIG. 10B, the quadri-pole magnetic fields respectively generated by the upper and lower three coils results in a composite magnetic field having a vertically asymmetrical configuration. This is, the asymmetrical quadri-pole field can be generated by coupling the three upper coils 27A, 27B, and 27C apparently with the coil 28B opposing the coil 27B. On the other hands, the asymmetrical quadri-pole field can be also generated by coupling the three lower coils 28A, 28B, and 28C apparently with the coil 27B opposing the coil 28B.

FIG. 10C shows variation of the magnetic flux density on the Y-axis (vertical axis) by the upper coils 27A, 27B, and 27C. As seen from the magnetic field distribution shown, the magnetic field distribution having a strong interaction with the upper electron beam (first electron beam) 19A but a weak interaction with the lower electron beam (second electron beam) 19B is obtained.

Thus, providing an asymmetrical quadri-pole magnetic field allows to be implemented the velocity modulation coils capable of independently controlling only the upper electron beam without appreciably affecting the lower electron beam. The three lower coils 28A, 28B, and 28C of the velocity modulation coils 17 provide a magnetic flux density having an axial symmetry with respect to the axis of the magnetic flux density shown in FIG. 10C, which allows to be implemented the velocity modulation coils capable of independently controlling only the lower electron beam 19B without appreciably affecting the upper electron beam 19A.

It should be understood that although the projection-type cathode ray tube wherein two electron beams are emitted has been described in the above embodiment, the invention is not limited to this embodiment. The other projection-type cathode ray tube wherein more than two electron beams are emitted is available. Although the velocity modulation coils 17 and the sub-deflection yoke 16 are integrated with the main deflection yoke 15 in the above embodiment, they can be provided as three separate elements.

As described above, according to the invention, since the velocity modulation coils have a coil configuration including three upper coils and three lower coils relative to the emitting direction of each of the electron beams to generate asymmetrical quadri-pole magnetic fields, it is capable of almost independently modulating the scanning velocities of the multiple electron beams, with one quadri-pole magnetic field by the three upper coils modulating only one electron beam and the other quadri-pole magnetic field by the three lower coils modulating only the other electron beam.

### INDUSTRIAL APPLICABILITY

A velocity modulation apparatus and a projection-type display according to the invention are applicable to a projection-type display having a large-sized screen and incorporating multiple projection-type cathode ray tubes.

1. A velocity modulation apparatus for allowing a current to pass through a velocity modulation coil of cathode ray tube to modulate scanning velocities of multiple electron beams emitted from electron guns built in a neck portion of said cathode ray tube, thereby sharpening an outline of a picture,
wherein the velocity modulation coil has a coil configuration including three upper coils and three lower coils relative to an emitting direction of each of said electron beams, for respectively generating asymmetrical quadri-pole magnetic fields to independently modulate the scanning velocities of said multiple electron beams.

2. The velocity modulation apparatus according to claim 1, wherein said electron beams are two electron beams; and
wherein said three upper coils interact only with a first electron beam of said electron beams to avoid interacting with a second electron beam thereof and said three lower coils interact only with said second electron beam to avoid interacting with said first electron beam.

3. A projection-type display equipped with multiple projection-type cathode ray tubes each having a velocity modulation apparatus, said velocity modulation apparatus allowing a current to pass through a velocity modulation coil of cathode ray tube to modulate scanning velocities of multiple electron beams emitted from electron guns built in a neck portion of said cathode ray tube, thereby sharpening an outline of a picture,
wherein the velocity modulation coil has a coil configuration including three upper coils and three lower coils relative to an emitting direction of each of said electron beams, for respectively generating asymmetrical quadri-pole magnetic fields to independently modulate the scanning velocities of said multiple electron beams.

4. The velocity modulation apparatus according to claim 3, wherein said electron beams are two electron beams; and
wherein said three upper coils interact only with a first electron beam of said electron beams to avoid interacting with a second electron beam thereof and said three lower coils interact only with said second electron beam to avoid interacting with said first electron beam.
